(19) United States
(12) Patent Application Publication
(10) Pub. No.: US 2010/0169517 A1
(43) Pub. Date: Jul. 1, 2010

(54) Multimedia Switch Circuit and Method

(75) Inventor: Ajinder Pal Singh, Murphy, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/345,966

(22) Filed: Dec. 30, 2008

(51) Int. Cl. G06F 3/00

(52) U.S. Cl. 710/36

(57) ABSTRACT

A detection circuit indicates when a source device is coupled to a sink. An interface circuit separately interfaces with the plurality of source devices and permits display identification data associated with an interfaced source device to be sent from the memory unit to the interfaced source device. A monitoring unit monitors communications between the plurality of source devices and a memory unit and generates a signal for the plurality of source devices upon identifying that the memory unit is available for storing display identification data that is associated with a remaining source device of the plurality of source devices. The signal is communicated to the control unit to cause the control unit to update the memory unit with the display identification data that is associated with the remaining source device(s). A power detection circuit powers the sink via power from a source device(s) in a low-power mode.

### TECHNICAL FIELD

This invention relates generally to circuitry for connecting source devices to a display device.

### BACKGROUND

With ever increasing demand for Digital Television (DTV) and for devices operating under the High Definition Multimedia Interface (HDMI) standard, a popular technology for connecting audio-visual equipment to display devices, the number of HDMI ports on display devices has been increasing. In a typical configuration, for example, these HDMI ports are connected to different sources (television signal sources, digital video disk (DVD) players, gaming devices, mobile devices, and the like) and are ready to be switched from one source to another. Typically, switching from one source to another is accomplished by switches at the display device that pass High-bandwidth-Digital-Content-Protection (HDCP) encrypted audio-visual content from the selected source through to the receiver. The display device usually includes circuitry call a sink or sink device that includes these switches.

HDMI devices typically implement plug and play functionality. Such functionality requires the source (for example a gaming counsel) to read the video and audio capability of the display device. The source is typically required to use a protocol called Display Data Channel (DDC) or Enhanced Display Data Channel (E-DDC) protocol to read this data from the sink. The data is typically organized in a format called Extended Display Identification Data (EDID) or E-EDID (Enhanced Extended Display Identification Data). This data is typically stored in memory such as an EEPROM (Electrically Erasable Programmable Read-Only Memory) at the sink side. Once the source has read the EDID data and further ensured that sink or display device is HDCP authenticated, it transmits the HDCP encrypted audio-visual data to the display device for playback.

Consumer Electronics Control (CEC) is an optional feature of the HDMI interconnection used for centralizing and simplifying user control instructions from multiple audio/video products in an inter-connected system. This feature reduces the number of remote controls in a system. CEC communication typically occurs over a single CEC wire within the HDMI cable. Each source device that is inter-connected via CEC has a physical and logical address for communication. The source CEC physical address of each source device is stored within the EDID data structure at the sink side to which that source is connected. If more than one source is connected to a sink, the HDMI standard requires that the sink store and ensure availability of the CEC physical address for each connected source within the EDID structure. Even when the sink is in a Low Power mode, or powered off, all connected sources should be able to read the EDID upon receiving a signal that the source is connected, such as a Hot Plug Detect (HPD) high signal from the source's cable, to obtain each source's assigned CEC physical address.

Many known devices that support such features include the EDID data structure for each HDMI port that the sink supports in a separate EEPROM. Cost savings, however, can be had by using only a single memory unit. Known devices using only a single memory unit are available but fail to address certain desirable characteristics. For example, certain known single-memory sink devices have problems with source devices timing out upon connection. As per the HDMI 1.3a standard, when a sink detects a five volt signal from an HDMI source, the source device expects to receive a signal from the sink within 20 milliseconds to let the source device know that it can read the EDID content from the sink. If the sink is not able to provide the EDID within 20 milliseconds, the source will time out. In some cases, the source device times out before 20 milliseconds, thereby requiring that the sink provide the EDID data as soon as it detects the five volt signal from the source indicating that the source device has been connected to the sink.

### SUMMARY

Generally speaking and pursuant to these various embodiments, an example multimedia interface system includes a detection circuit that indicates when each of a plurality of source devices have been coupled thereto, an interface circuit, and a memory unit. The interface circuit is configured to separately interface with each of the plurality of source devices wherein the interface circuit permits display identification data that is associated with an interfaced source device of the plurality of source devices to be sent from the memory unit to the interfaced source device. A monitoring unit is adapted to monitor communications between the plurality of source devices and the memory unit, wherein the monitoring unit generates a signal for each of the plurality of source devices upon identifying that the memory unit is available for storing display identification data that is associated with a remaining source device of the plurality of source devices. The signal is communicated to the control unit to cause the control unit to update the memory unit with the display identification data that is associated with the remaining source device(s). In one approach, the system includes a power detection circuit configured to permit powering of the memory unit via power supplied from at least one of the plurality of source devices while the sink device operates in a low-power mode.

So configured, the system is able to provide display identification data, such as EDID, to source devices before the source devices time out. Also, the power arrangement allows such a system to run in a low power mode and power up from such a low power mode using power provided by a source device thereby allowing the sink to send display identification data even in a low power mode.

### BRIEF DESCRIPTION OF THE DRAWINGS

The above needs are at least partially met through the provision of the multimedia switch circuit and method described in the following detailed description, particularly when studied in conjunction with the drawings wherein:

FIG. 1 comprises a flow diagram of an example method of operation of a multimedia interface as configured in accordance with various embodiments of the invention;

FIG. 2 comprises a block diagram of an example multimedia interface system and circuit as configured in accordance with various embodiments of the invention;

FIG. 3 comprises an example multimedia system block diagram as configured in accordance with various embodiments of the invention;

FIG. 4 comprises a data flow diagram for an example multimedia system as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE PREFERRED EMBODIMENT(S)

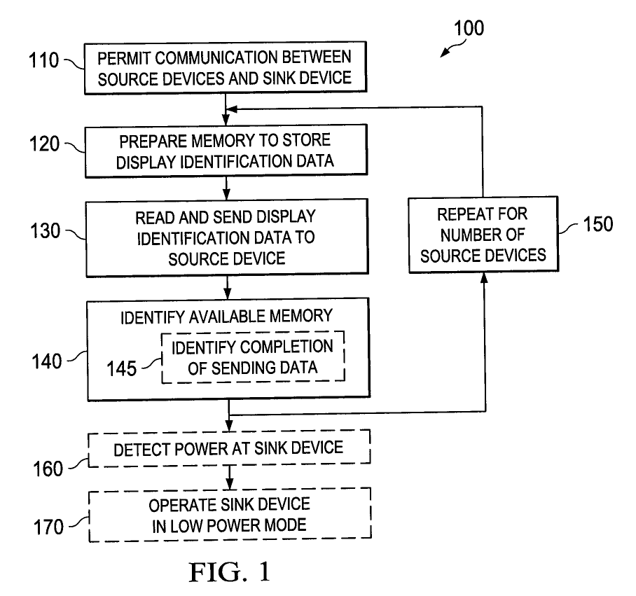

Referring now to the drawings, and in particular to FIG. 1, an illustrative process 100 compatible with many of these teachings will now be presented. A method for establishing communication paths via a multimedia interface includes at step 110 permitting communication between a plurality of source devices and a sink device via a corresponding plurality of data paths. In one example, the plurality of data paths include a plurality of Display Data Channels (DDC). At step 120 the method includes preparing memory of the sink device to store identification data associated with a particular source device of the plurality of source devices. In one example, the display identification data comprises at least one data type of display data characteristics for the sink device, a physical address for Consumer Electronics Control (CEC) information, or a check sum. In yet another example, the display identification data comprises Extended Display Identification Data (EDID).

At step 130 the method includes reading display identification data from the memory for sending to the particular source device via a corresponding data path of the plurality of data paths. At step 140 the method includes identifying that the memory is available for storing further display identification data that is associated with another source device of the plurality of source devices. In one approach, this step 140 may include an additional step 145 of monitoring the plurality of data paths to identify completion of the sending of the display identification data to the particular source device. In this example, the completion indicates that the memory is available to store further display identification data. In another example, the step 140 of identifying further comprises identifying completion of the reading the display identification data from the memory wherein the completion of the reading indicates that the memory is available to store further display identification data.

As indicated at step 150, steps 120, 130, and 140 are to be repeated for at least a number of the plurality of source devices in response to the identifying that the memory is available for storing further display identification data. In other words, by one approach, the method includes storing display identification data, reading and sending the display identification data to the source device, and identifying additional available memory sequentially for each source device that is connected to the sink device. One such sequential approach is called a shadow RAM (Random Access Memory) approach wherein certain operating system routines, such as a Basic Input/Output operating System (BIOS) routine, read data from Read-Only Memory (ROM) into a special area of random access memory so that the data can be accessed sequentially by different sources connected to the sink. The time period for performing the operations of steps 120, 130, and 140 may vary for each of the plurality of source devices depending on the configuration of the interface between the source device and the sink device.

So configured, this method for operating multimedia interface at the sink device allows aggressive provision of display identification data to the plurality of source devices interfaced to the sink device sequentially and to avoid timing out of the source devices.

In another example approach, the method includes at step 160 detecting power at the sink device as received from one of the plurality of source devices. At step 170 the memory and a controller of the sink device are powered during a period of time to operate the sink device in a low power mode while no Audio/Video (A/V) data is received at the sink device from any of the plurality of source devices. In one approach, the A/V data comprises Transition Minimized Differential Signaling (TMDS) data. By this approach, the sink device may operate in a low power mode when no data is being received such that power usage from the display device may be reduced. In this mode, the sink device may be powered by the power source from one or more of the source devices. For example, source devices typically provide a five volt signal as part of the connection to the sink device. Accordingly, the sink device by this approach will use the five volt signal from one or more of the source devices to power its operation when operating in a low power mode and to power up from the low power mode.

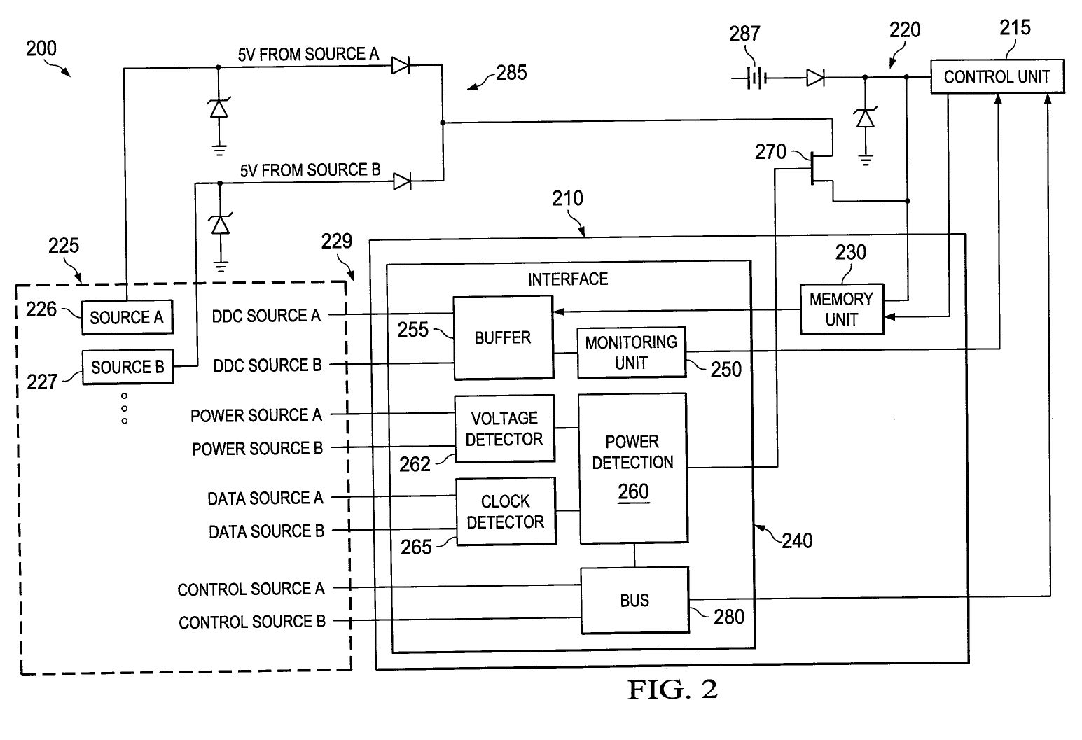

With reference to FIG. 2, an example system for performing the above methods will be described. The system 200 for interfacing to a plurality 225 of source devices includes a plurality of interfaces 229 adapted to connect to source devices 226 and 227. The system 200 also includes a control unit 215 such as a microcontroller or the like. A detection circuit 210 is in communication with the plurality of interfaces 229. The detection circuit 210 is configured to indicate to the control unit 215 that a number of the plurality 225 of source devices have been coupled to the system 200. A memory unit 230 is adapted to receive from the control unit 215 display identification data that is separately associated with an interfaced source device 226 in response to the control unit's 215 receiving indication that the interfaced source device 226 is coupled to the system 200. The memory unit 230 may be an EEPROM or RAM or other suitable memory device.

An interface circuit 240 is in communication with the plurality of interfaces 229. The interface circuit 240 is adapted to permit the display identification data associated with the interface source device 226 and that was stored in the memory unit 230 to be sent from the memory unit 230 to the interfaced source device 226. The memory unit 230 may be located in the interface circuit 240 or outside of the interface circuit 240. By another approach, the memory unit 230 may be incorporated into the control unit 215. In one approach, the interface circuit 240 is a TMDS switch for switching the source device signals, such as HDMI signals, to the display device. By one approach, the interface circuit 240 includes a buffer circuit 255 through which the display identification data from the memory unit 230 is sent to the interfaced source device 226.

A monitoring unit 250 is in communication with the memory unit 230 and adapted to generate a signal via the plurality of interfaces 229 for a number of the plurality 225 of source devices upon identifying that the memory unit 230 is available for storing display identification data associated with the remaining source device 227 of the plurality 225 of source devices. For example, the monitoring unit 250 may be configured to watch the status of the buffer circuit 255 connected to the memory unit 230 to determine whether display identification data stored in the buffer circuit 255 for sending to a source device has been sent. The monitoring circuit 250 indicates to the control unit 215 through an interrupt (IRQ) signal that additional memory is available for sending additional display identification data. The interrupt signal is communicated to the control unit 215 to cause the control unit 215 to update the memory unit 230 with the display identification data that is associated with the remaining source device 227.

In one approach, the detection circuitry 210 includes a power detection circuit 260 configured to permit powering of the memory unit 230 via power supplied from at least one of the plurality 225 of source devices while the sink device 220 operates in a low-power mode. In one such example, the power detection circuit 260 is configured to detect power received from one of the plurality 225 of source devices and is in communication with the voltage detector 262 that is connected to the power source for each of the connected source devices 226 and 227. A data detection circuit 265 is configured to detect audio/video (A/V) data as received at the sink device 220 from any of the plurality of source devices. In one approach, the data detection circuit 265 comprises a TMDS clock detect circuit. The power detection circuit 260 is in communication with both the voltage detector 262 and the data detection circuit 265 and is configured to execute logic to determine how to configure a switch 270. The switch 270 is configured to permit powering of the control unit 215 and the memory unit 230 via power supplied from at least one of the plurality 225 of source devices only if the data detection circuit 265 does not detect the A/V data. By one approach, the switch 270 comprises a transistor controlled by the power detection circuit 260 such that the transistor and associated circuitry switches the power for the control unit 215 between the five volt source 285 from a source device and a system power source 287.

A bus 280 is in communication with the plurality 225 of source devices and the control unit 215 to facilitate communication among the various elements of the system. In one example, the bus 280 is a dedicated slave I2C (Inter-Integrated Circuit bus) from the control unit 215 to the interface circuit 240 to control the HPD signals for each of the connected sources individually, thereby enabling the sink to assert HPD high or low for all the sources or more than one source at the same time. So configured, the control unit 215 can enable each source to read the EDID from the single EEPROM one at a time when the five volt HPD high signal is detected.

Those skilled in the art will recognize and understand that such an apparatus 200 may be comprised of a plurality of physically distinct elements as is demonstrated by the illustration shown in FIG. 2. It is also possible, however, to view this illustration as comprising a logical view in which case one or more of these elements can be enabled and realized via a shared platform. It will also be understood that such a shared platform may comprise a wholly or at least partially programmable platform as is known in the art.

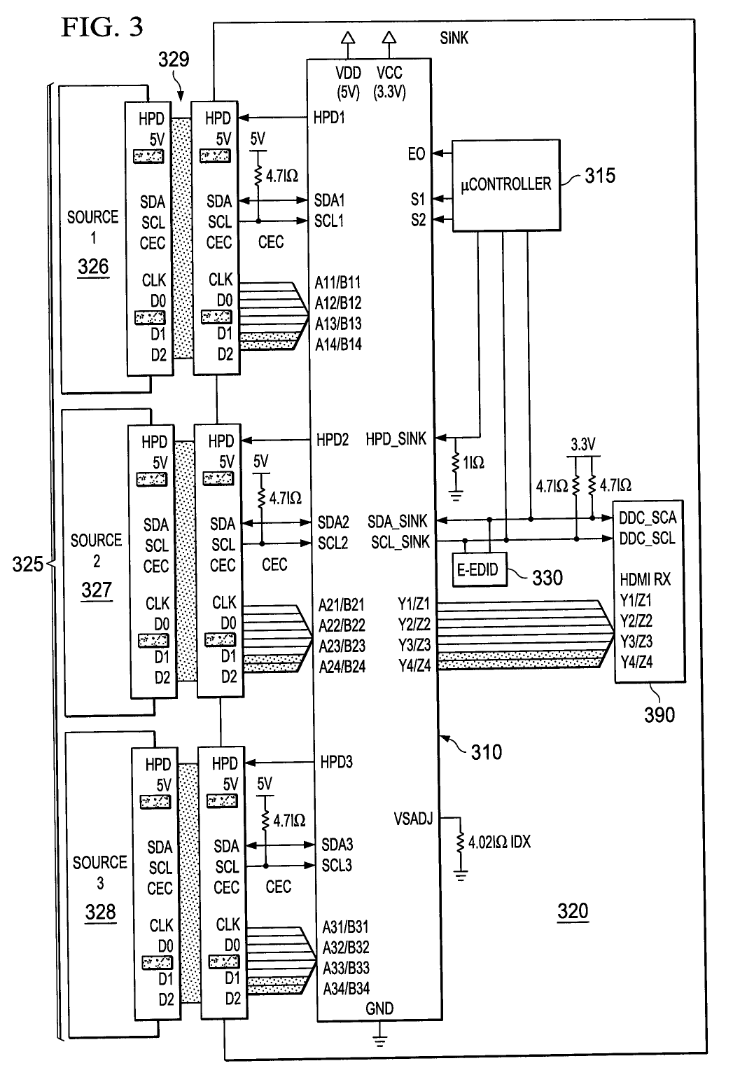

For example, and with reference to FIG. 3, one such example implementation will be described. In this example, the detection circuit 210, interface circuit 240, and monitoring unit 250 are combined into a single TMDS chip 310 for the sink device 320. Within the chip 310, the detection circuit indicates when each of the plurality 325 of source devices have been coupled thereto. The interface circuit of the chip 310 is configured to separately interface each of the plurality 325 of source devices and the memory unit 330. Here, the interface circuit permits the display identification data associated with an interfaced source device 326 of the plurality 325 of source devices and that was stored in the memory unit 330 after the detection unit indicated coupling of each of the plurality 325 of source devices 326, 327, and 328 to be sent to the memory unit 330 to the interface source device 326.

The monitoring unit of the chip 310, in this example, is adapted to monitor communications between the plurality 325 of source devices and the memory unit 330. The monitoring unit generates a signal for each of the plurality of 325 of source devices upon identifying that the memory unit 330 is available for storing display identification data that is associated with the remaining source device 327 of the plurality 325 of source devices. The signal is communicated to the control unit 315 to cause the control unit 315 to update the memory unit 330 with the display identification data that is associated with the remaining source device 327. The power detection circuit, data detection circuit, and switch may also be included in the chip 310 of FIG. 3. Additional circuitry 390 is included to facilitate communication of audio/video data received by the chip 310 to the display device for the sink device 320. The switch element 270 of FIG. 2 is typically implemented at a system level not shown in FIG. 3.

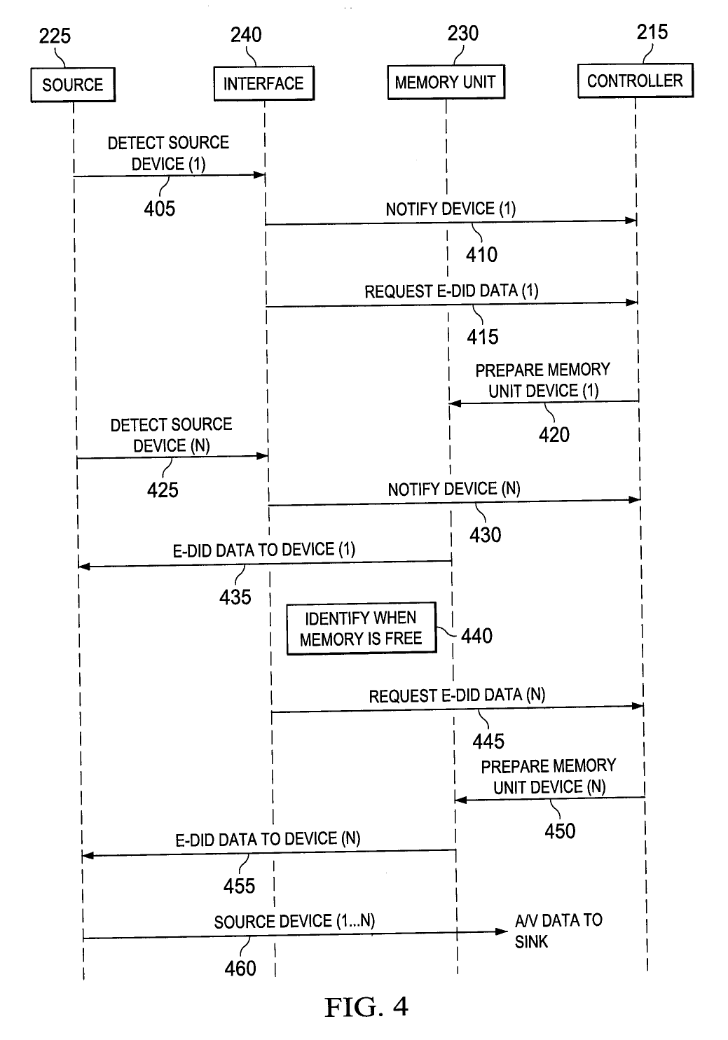

With reference to FIG. 4, data flow among the various elements of the described multimedia interface device will be described. When a source device of the plurality 225 of sources is plugged into a display device having a sink as described herein at point 405, the signal from the source device side 225 is detected by the interface circuit 240. At step 410, the interface circuit 240 notifies the controller 215 that the source device has been detected. The interface circuit 240 then at step 415 requests display identification data such as EDID data to send to the source device side 225. At step 420 the controller 215 prepares the memory unit for storing display identification data for the connected source device. Then, at step 425 another source device, number N, is connected from the plurality 225 of source devices, and the connection is detected by the interface circuit 240. At step 430 a controller 215 is notified that the additional source device has been connected. At step 435 display identification data is sent from the memory circuit 230 to the first source device of the plurality 225 of source devices. When the display identification data is sent, the monitoring circuit identifies at step 440 that memory is free for the requesting of additional display identification data. Accordingly, at step 445, the interface circuit 240 requests additional display identification data for the source device N at step 425. Then at step 450 the controller 215 prepares the memory unit for display identification data for the source device N. At step 455 the display identification data is transmitted to the source device N to allow for operation of the source device. Upon completion of sending the E-DID to each of the connected sources devices 1 through N, the source devices can provide audio/video data to the sink device for display at the display device.

So configured, the multimedia interface enables transmission of display identification data to various source devices that are connected to a single sink device from a single memory unit. The interface supplies this information in good time to avoid timing out of the sourced devices such that each of the source devices reliably provides multimedia information for display on the display device associated with the sink device. Moreover, when no audio/video data is being received by the sink, the sink may be powered by the source device power such that the sink chip may operate in a low power mode not powered by the display device, thereby reducing its power consumption and allowing display identification data to be immediately read from the sink device while operating in the low power mode to reduce delays in display identification data provision. The sink may also use the source device power to power up from the low power mode, further reduce power usage from the display device. An interface as disclosed herein may also be used be a variety of HDMI repeater circuits.

Those skilled in the art will recognize that a wide variety of modifications, alterations, and combinations can be made with respect to the above described embodiment without departing from the scope of the invention, and that such modifications, alterations, and combinations are to be viewed as being within the ambit of the inventive concept.

What is claimed is:

1. A method for establishing communication paths via a multimedia interface, the method comprising:
(a) permitting communication between a plurality of source devices and a sink device via a corresponding plurality of data paths;
(b) preparing memory of the sink device to store display identification data associated with a particular source device of the plurality of source devices;
(c) reading display identification data from the memory for sending to the particular source device via a corresponding data path of the plurality of data paths;
(d) identifying that the memory is available for storing further display identification data that is associated with another source device of the plurality of source devices;
(e) responsive to the identifying that the memory is available for storing, repeating operations (b) though (d) for at least a number of the plurality of source devices.

2. The method according to claim 1, wherein the step of identifying further comprises monitoring the plurality of data paths to identify completion of the sending of the display identification data to the particular source device, wherein the completion indicates that the memory is available to store further display identification data.

3. The method according to claim 1, wherein the step of identifying further comprises identifying completion of the reading of the display identification data from the memory, wherein the completion of the reading indicates that the memory is available to store further display identification data.

4. The method according to claim 1, the method further comprises:
detecting power at the sink device as received from one of the plurality of source devices; and
powering the memory and a controller of the sink device during a period of time to operate the sink device in a low power mode while no audio/video (A/V) data is received at the sink device from any of the plurality of source devices.

5. The method according to claim 4, wherein the A/V data comprises transition minimized differential signaling (TMDS) data.

6. The method according to claim 1, wherein a time period for performing operations (b) though (d) varies for each of the plurality of source devices.

7. The method according to claim 1, wherein at least one of the plurality of data paths comprises a display data channel (DDC) or an enhanced display data channel.

8. The method according to claim 1, wherein the display identification data comprises at least one of display data characteristics of the sink device, a physical address for consumer electronics control (CEC), or a checksum.

9. The method according to claim 1, wherein the display identification data comprises extended display identification data (EDID) or enhanced extended display identification data (E-EDID).

10. A multimedia interface for a sink device, comprising:
a detection circuit that indicates when each of a plurality of source devices have been coupled thereto;
an interface circuit configured to separately interface each of the plurality of source devices and a memory unit, wherein the interface circuit permits display identification data that is associated with an interfaced source device of the plurality of source devices and that was stored in the memory unit after the detection unit indicated coupling of each of the plurality of source devices to be sent from the memory unit to the interfaced source device; and
a monitoring unit adapted to monitor communications between the plurality of source devices and the memory unit, wherein the monitoring unit generates a signal for each of the plurality of source devices upon identifying that the memory unit is available for storing display identification data that is associated with a remaining source device of the plurality of source devices, and wherein the signal is communicated to the control unit to cause the control unit to update the memory unit with the display identification data that is associated with the remaining source device.

11. The multimedia interface according to claim 10, wherein the detection circuit further comprises a power detection circuit configured to permit powering of the memory unit via power supplied from at least one of the plurality of source devices while the sink device operates in a low-power mode.

12. The multimedia interface according to claim 10,
wherein the detection circuit further comprises:
a power detection circuit configured to detect power received from one of the plurality of source devices; and
a data detection circuit configured to detect audio/video (A/V) data that is received at the sink device from any of the plurality of source devices; and
the multimedia interface further comprises a switch configured to permit powering of the control unit and the memory unit via power supplied from at least one of the plurality of source devices only if the data detection circuit does not detect the A/V data.

13. The multimedia interface according to claim 10, wherein the display identification data comprises at least one data type of a display data characteristics of the sink device, a physical address for consumer electronics control (CEC), or a checksum.

14. The multimedia interface according to claim 10, wherein the display identification data comprises extended display identification data (EDID) or enhanced extended display identification data (E-EDID).

15. A system for interfacing to a plurality of source devices, the system comprising:
a plurality of interfaces adapted to connect to source devices;
a control unit;
a detection circuit in communication with the plurality of interfaces, the detection circuit configured to indicate to the control unit that a number of the plurality of source devices have been coupled to the system;
a memory unit adapted to receive from the control unit display identification data that is separately associated with an interfaced source device in response to the control unit's receiving indication that the interfaced source device is coupled to the system;
an interface circuit in communication with the plurality of interfaces, the interface circuit adapted to permit the display identification data associated with the interfaced source device and that was stored in the memory unit to be sent from the memory unit to the interfaced source device;
a monitoring unit in communication with the memory unit and adapted to generate a signal via the plurality of interfaces for a number of the plurality of source devices upon identifying that the memory unit is available for storing display identification data associated with a remaining source device of the plurality of source devices, and wherein the signal is communicated to the control unit to cause the control unit to update the memory unit with the display identification data that is associated with the remaining source device.

16. The system of claim 15, wherein the detection circuit further comprises a power detection circuit configured to permit powering of the memory unit via power supplied from at least one of the plurality of source devices while the sink device operates in a low-power mode.

17. The system of claim 15, further comprising:
a power detection circuit configured to detect power received from one of the plurality of source devices; and
a data detection circuit configured to detect audio/video (A/V) data that is received at the sink device from any of the plurality of source devices; and
a switch configured to permit powering of the control unit and the memory via power supplied from at least one of the plurality of source devices only if the data detection circuit does not detect the A/V data.

18. The system of claim 15, wherein the display identification data comprises at least one data type of a display data characteristics of the sink device, a physical address for consumer electronics control (CEC), or a checksum.

19. The system of claim 15, wherein the display identification data comprises extended display identification data (EDID) or enhanced extended display identification data (E-EDID).
